(19) United States
(12) Patent Application Publication
(10) Pub. No.: US 2007/0287016 A1
(43) Pub. Date: Dec. 13, 2007

(54) Method of painting plated resin part, painted plated resin part and electronic device using the same

(75) Inventor: Kazuyuki Kinjou, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/783,688

(22) Filed: Apr. 11, 2007

(30) Foreign Application Priority Data
Apr. 25, 2006 (JP) 2006-120848

(51) Int. Cl. B32B 13/08; B05D 7/00

(52) U.S. Cl. 428/461; 427/409; 205/283

(57) ABSTRACT

According to one embodiment, a painted plated resin part including a resin part, a trivalent chromium layer plated on the resin part, and a painting containing a primer coat of a one-pack acryl resin paint formed on the trivalent chromium layer, and a topcoat of two-pack urethane resin paint formed on the primer coat.

### CROSS-REFERENCE TO RELATED APPLICATIONS

This application is based upon and claims the benefit of priority from Japanese Patent Application No. 2006-120848, filed Apr. 25, 2006, the entire contents of which are incorporated herein by reference.

### BACKGROUND

1. Field

One embodiment of the invention relates to a method of painting a surface of a plated resin part, a plated resin part painted by this method, and an electronic device that employs a plated resin part thus painted.

2. Description of the Related Art

Lightweight and easily moldable resin parts are used in various fields.

In order to improve the design, such resin parts may be subjected to metal plating.

For example, when trivalent chromium plating is applied to the surface of a resin-made exterior part of an electronic device, an imposing and upscale image can be added to the part.

However, a plated chromium layer has a low wear resistance. Therefore, when it is employed in a part that is frequently touched with human fingers, such as a manipulation button part, the part is easily soiled with fingerprints or peeled off. Therefore, for protection, such a part is painted. For painting, a urethane resin-based two-pack topcoat is used. Further, as disclosed in Jpn. Pat. Appln. KOKAI Publication No. 2005-296841, there is a conventional method that can enhance the adherence between a topcoat and a plated chromium layer, in which a primer coat having ingredients similar to those of the topcoat is provided in advance to coarse the surface and then the two-pack topcoat is painted.

Even with the conventional technique, it is still not possible to obtain a sufficiently adherence between the surface of the plated chromium layer and the painting or a sufficient wear-resisting property.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing a cross section of a model example of a plated resin part painted according to the present invention;

FIG. 2 is a diagram showing an appearance of a structure of an example of an electronic device according to the present invention; and

FIG. 3 is a diagram showing an appearance of an example of a plated resin part that can be painted using the present invention.

### DETAILED DESCRIPTION

Various embodiments according to the invention will be described hereinafter with reference to the accompanying drawings. In general, according to one embodiment of the invention, a plated resin part painted by the present invention includes a resin part, a trivalent chromium layer plated on the resin part, and a painting applied on the trivalent chromium layer. The painting includes a primer coat formed on the trivalent chromium layer and a topcoat applied thereon. The primer coat is formed by applying a one-pack acryl resin-based paint on the surface of the part and the topcoat is formed by applying a two-pack urethane resin-based paint thereon.

The plated resin part is obtained using a painting method which comprises the plated resin part painted by the present invention includes a resin part, a trivalent chromium layer plated on the resin part, and a painting applied on the trivalent chromium layer. The painting includes a primer coat formed on the trivalent chromium layer and a topcoat applied thereon. The primer coat is formed by applying a one-pack acryl resin-based paint on the surface of the part and the topcoat is formed by applying a two-pack urethane resin-based paint thereon.

The plated resin part is obtained using a painting method which comprises the following steps: forming a chromium-plated layer by plating trivalent chromium on a surface of a resin part; applying a 1-liquid acryl resin-based paint on the chromium-plated layer, thereby forming a primer coat; and applying a two-pack urethane resin-based paint on the primer coat, to form a topcoat, thereby finishing painting.

The electronic device of the present invention includes an exterior member to at least a part of which the painted plated resin part is applied, and an electronic part housed in the exterior member.

In the case where the resin part has a smooth surface, the plated chromium layer will have a smooth surface as well. If a topcoat is formed directly on a smooth surface, it is difficult to obtain a sufficient adhesion. The primer coat serves to rough the preformed smooth surface before forming the topcoat, thereby increasing the contacting surface with the topcoat formed thereon. Thus, the adhesion is improved and the peeling-off of a layer from another layer can be suppressed, thereby making it possible to improve the resistance to wear.

Further, according to the present invention, a two-pack urethane-based paint is employed for the topcoat, whereas a 1-liquid acryl resin-based paint is employed for the primer coat. Thus, even a better adhesion can be achieved.

The carboxyl group contained in the 1-liquid acryl resin-based paint is expressed by the following chemical formula (1):
—COOH (1)

Here, it should be noted that of O and H at the terminal end of the carboxyl group, O has a higher electronegativity as compared to that of H, and therefore covalent electron pairs e⁻ gather around O. As a result, O becomes negatively charged, whereas H positively charged as indicated in the following formula (2).
—COO⁻—H⁺ (2).

It should be noted that the electronegativity is a strength of attracting covalent electron pairs, and it is expressed in the order of H<C<N<O<F, whose values are 2.1, 2.5, 3.0, 3.5 and 4.0, respectively.

On the other hand, the urethane group contained in the 2-liquid urethane resin-based paint is expressed by the following chemical formula (3):
—NHCOOR (3)

Here, it should be noted that of N and H in the carboxyl group, N has a higher electronegativity as compared to that of H, and therefore covalent electron pairs e⁻ gather around N. As a result, N becomes negatively charged, whereas H positively charged as indicated in the following formula (4).
—N⁻—H⁺COOR (4).

The trivalent chromium plate usually contains, as minute components, 0.03 to 0.1 atomic % of hydrogen atom and 0.2 to 0.5 atomic % of oxygen atom.

The comparison between the carboxyl group of the one-pack acryl resin-based paint and the urethane group of the two-pack urethane-based paint indicates that O⁻ of the carboxyl group of the one-pack acryl resin-based paint has a higher electronegativity as compared to that of N⁻ of the urethane group of the two-pack urethane-based paint, and therefore O⁻ has a stronger force of attracting the charged hydrogen H⁺ on the trivalent chromium plated surface. Thus, the adhesion is improved. In addition, H⁺ of the carboxyl group of the one-pack acryl resin-based paint tends to be isolated therefrom, thereby becoming acidic. As a result, the chromium-plated layer is affected, thereby easily roughing the surface. Thus, a more contact surface with the primer coat can be obtained and therefore a higher adhesion can be achieved.

For the reason described above, when the one-pack acryl resin-based paint is used for the primer coat, an excellent adhesion can be obtained and the resistance to wear can be improved as compared to the case where a two-pack urethane-based paint similar to the two-pack urethane-based paint used for the topcoat is used for the primer coat.

Usable examples of the two-pack urethane-based paint used in the present invention are those in which polyol resin is used as the main component and isocyanate resin is used as the hardening agent. Such a two-pack urethane-based paint can form a coating having a net structure due to its crosslinking reaction. When the main component and the hardening ahget are mixed together, the mixture transforms from the free-flowing state to a stringy state as the time passes. Then, when the hardening proceeds, the mixture becomes gel and thereafter, it hardens sufficiently.

Usable examples of the one-pack acryl resin-based paint used in the present invention are those in which polymethyl methacrylate (usually known as PMMA) is used as the main component. Such a one-pack acryl resin-based paint can form a coating when the solvent evaporates. A hardening agent is not employed.

The main component herein mentioned is an element or elements having the highest component ratio of components forming the material.

The present invention will now be described in more detail with reference to accompanying drawings.

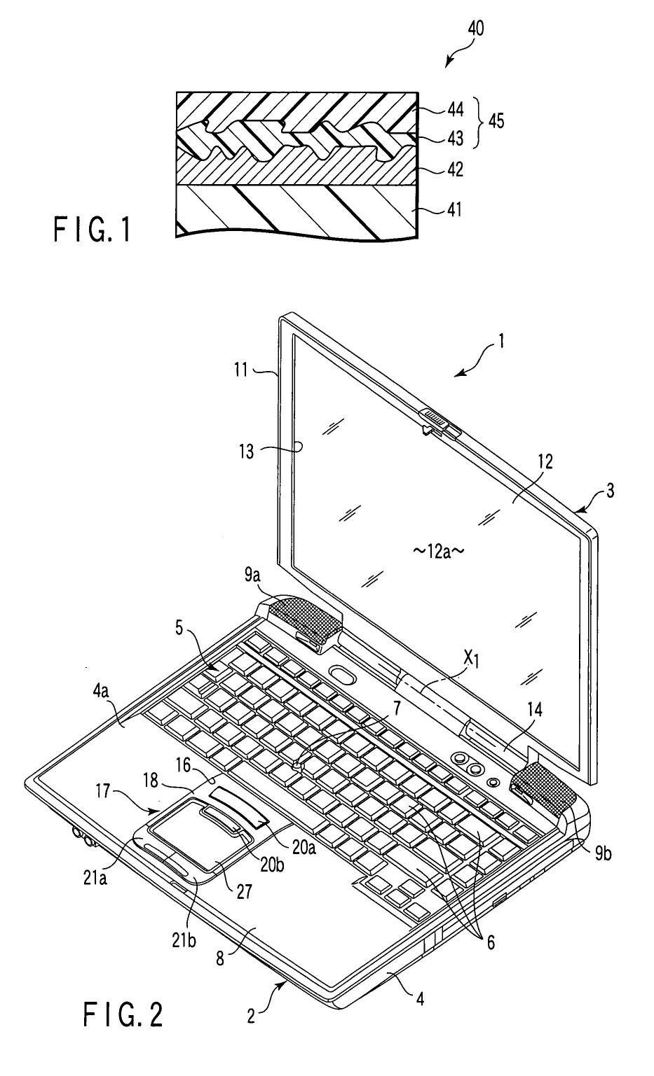

FIG. 1 is a diagram showing a model of a structure of a cross section of a plated resin part painted with the present invention.

As shown in this figure, the plated resin part 40 has such a structure that a trivalent chromium layer 42 and a painting 45 are formed on a resin part 41 made of, for example, an ABS resin. The painting 45 includes a primer coat formed of the one-pack acryl resin-based paint and a topcoat 44 formed of the two-pack urethane-based paint.

Examples of the resin are ABS resins and polycarbonate resins.

FIG. 2 is a diagram showing an appearance of a structure of an example of the electronic device according to the present invention.

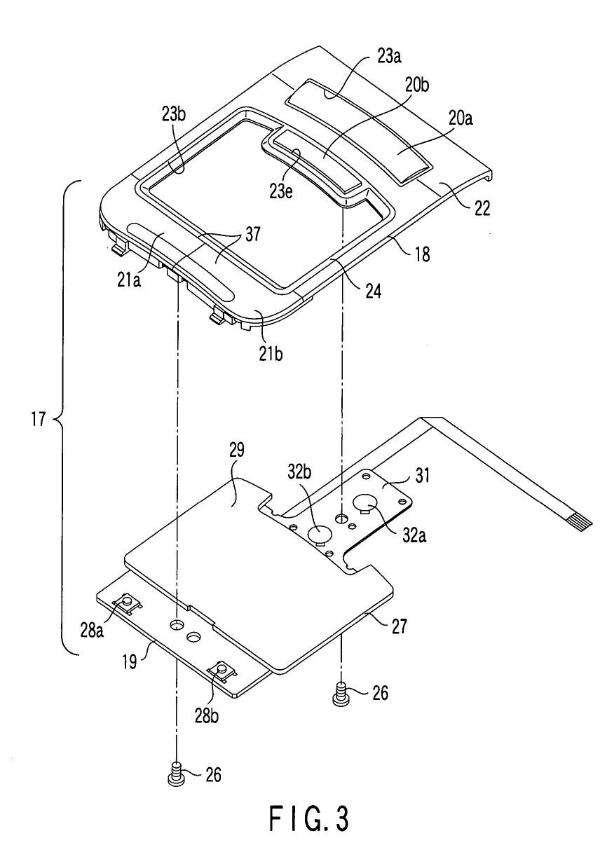

FIG. 3 is a diagram showing an appearance of an example of the plated resin part that can be painted by the present invention.

With reference to FIGS. 2 and 3, an embodiment of the present invention will now be described.

FIG. 2 shows a portable computer 1, which is an electronic device. FIG. 3 shows touch pad operation button parts, which are resin parts used in the device shown in FIG. 2.

The portable computer 1 includes a computer main body 2 and a display unit 3.

The computer main body 2 includes a flat-box-shaped case 4. The case 4 includes an upper wall 4a serving as an outer wall. The upper wall 4a supports a keyboard 5. The keyboard 5 includes a number of key tops 6 and a joystick 7, which is a kind of the pointing device. The joystick 7 is located at a central part of the keyboard 5.

A front half portion of the upper wall 4a also serves as a palm rest 8 on which hands are rested when the keyboard 5 is operated. The palm rest 8 is located on a front side of the keyboard 5, and it extends in a width direction of the case 4. Further, a pair of speaker units 9a and 9b are mounted on an rear end of the upper wall 4a. The speaker units 9a and 9b are set apart from each other in a width direction of the case 4 and they protrude upward from the rear end of the upper wall 4a.

The display unit 3 comprises a display housing 11 and a liquid crystal display panel 12. The display housing 11 has a flat box shape, with a rectangular opening 13 made in its front surface. The liquid crystal display panel 12 includes a screen 12 that displays images. The screen 12a is exposed to the outside of the display housing 11 via the opening 13.

As shown in FIG. 2, the display housing 11 has leg portions 14 made on its one end. The leg portions 14 are guided between the speaker units 9a and 9b of the case 4, and they are joined to the rear end of the case 4 via hinges, which are not shown in the figure. Each of the hinges has a horizontal axial line X1 taken along the width direction of the case 4.

With the above-described structure, the display unit 3 is set pivotable between a closed position and an open position around the axial line X1 of the hinges, which serves as the pivotal center. At the closed position, the display unit 3 lies to cover the keyboard 5 and the palm rest 8 from the above. At the open position, the display unit 3 stands up with respect to the main body 2 of the computer, and the keyboard 5, palm rest 8 and screen 12a are exposed to the outside of the portable computer 1.

The palm rest 8 of the case 4 has a rectangular mount hole 16 at a central portion along its width direction. Touch pad operation button parts 17 are built in the mount hole 16 of the palm rest 8.

As shown in FIG. 3, the touch pad operation button parts 17 include a frame 18, a print circuit board 19, a pair of first click switch buttons 20a and 20b and a pair of second click switch buttons 21a and 21b.

The frame 18 is fit into the mount hole 16 of the palm rest 8. The frame 18 includes an upper surface 22 and first to fourth through holes 23a to 23d made in the upper surface 22. The upper surface 22 of the frame 18 is located on the same plane as that of the upper surface of the palm rest 8. The first through hole 23a has a rectangular shape elongating in the width direction of the case 4, and it is located at a rear end section of the frame 18 set next to the keyboard 5. The second through hole 23b is a rectangular opening, and it is located at a central section of the frame 18. A rim 24 is fit into edges of the opening of the second through hole 23b. A fifth through hole 23e is formed in a front end portion of the rim 24. The fifth through hole 23e has a rectangular shape elongating in the width direction of the case 4, and it is located just in front of the first through hole 23a.

The print circuit board 19 is fixed to the back of the frame 18 via screws 26. A touch pad 27, which is a type of pointing device, and a pair of click switches 28a and 28b are mounted on an upper surface of the print circuit board 19. The touch pad 27 includes a flat input operating surface 29 to be manipulated by touch of the tip of a finger. The input operating surface 29 is exposed to the outside of the case 4 via the second through hole 23b. The click switches 28a and 28b are designed to execute or cancel a command used when the touch pad 27 is used. The click switches 28a and 28b are arranged to be in line and distant apart from each other in the width direction of the case 4 just in front of the touch pad 27, and they are located directly underneath the third and fourth through hole 23c and 23d.

Further, a flexible printed wiring board 31 is electrically connected to a rear end of the printed circuit board 19. The flexible printed wiring board 31 includes a pair of click switches 32a and 32b, which are different from those mentioned before. These click switches 32a and 32b are designed to execute or cancel a command used when the joystick 7 is used. The click switches 32a and 32b are arranged to be in line and distant apart from each other in the width direction of the case 4 just in front of the touch pad 27, and they are located directly underneath the first and fifth through hole 23a and 23e.

As shown in FIG. 3, the first click switch buttons 20a and 20b have a slender shape such as to fit the shape of the first and fifth through holes 23a and 23e. Thus, the first click switch buttons 20a and 20b are fit into the first and fifth through holes 23a and 23e from the lower side of the frame 18. Upper surfaces of the first click switch buttons 20a and 20b are exposed from an upper surface 18a of the frame 18 so that they can be pressed with the tip of a finger.

For example, the upper wall 4a, keyboard 5, touch pad operating button parts 17 and display housing 11 are formed mainly by injection molding of ABS resin. The surfaces of the case 4 and display unit 3, which form the outward appearance, can be finished with a trivalent chromium layer by plating.

Of the above-mentioned parts, portions that are frequently touched with human fingers such as a decorative cover part of the display housing 11, the touch pad operating button parts 17, audio operating button parts thought they are not shown in the figure, may be coated with a painting containing a primer coat of a one-pack acryl resin-based paint formed on the trivalent chromium layer and a topcoat of a two-pack urethane resin-based paint formed on the primer coat.

The present invention will now be described in more detail with reference to examples.

### EXAMPLE 1

Resin parts were painted in the following manner.

First, an ABS resin piece having a size of 8 mm×60 mm and a thickness of 2 mm was plated with a trivalent chromium layer having a thickness of 0.3 to 1 μm by a trivalent chromium treatment.

Painting of one-pack acryl resin paint:

A PMMA resin, which is the main ingredient of the one-pack acryl resin paint, and a thinner were mixed together, and the mixture was let stand for 5 minutes. The thus obtained resin was painted on the surface of the ABS resin piece by hand. After the painting, the coating was dried at a temperature of about 70 to 80° C. and thus the coating was cured, thereby obtaining a primer coat.

Painting of two-pack urethane resin paint:

A polyol resin, which is the main ingredient of the two-pack urethane resin paint, an isocyanate resin, which serves as a hardening agent, and a thinner were mixed together, and the mixture was painted on the surface of the primer coat. After the painting, the coating was dried at a temperature of about 70 to 80° C. and thus the coating was cured, thereby obtaining a topcoat. Thus, the painting of stacked layers of the primer coat and topcoat was finished, thereby obtaining a sample.

20 of samples similar to that obtained above were prepared.

The adhesion of the painting with respect to the trivalent chromium layer of the obtained sample was examined using a cross-cut testing method under ASTM D 3359.

First, 100 cuts in a pattern of squares of chessboard each having a width of 1 mm were made in the painted surface with a knife, and Scotch tape (tradename: Sellotape) having a width of 15 mm was adhered on the surface. The, the tape was peeled off from a direction of 45 degrees.

When the state of the painting stripped off was 4B or higher according to ASTM D 3359, that is, small thin pieces of the coating were stripped off at intersects of squares and the coating was affected by less than 5% in area, or better, it was evaluated as a pass.

The results indicated that all of the samples were evaluated to be 4B or higher.

### COMPARATIVE EXAMPLE 1

20 samples for comparison were prepared in the same manner as that of Example 1 except that a two-pack urethane resin paint, which has an effect of roughing the surface of the trivalent chromium layer was used to form the primer coat, in place of using the one-pack acryl resin paint.

The adhesion of the paint with respect to the trivalent chromium layer of the obtained sample was examined using a cross-cut testing method in the same manner as that of Example 1.

The results indicated that 10 of the samples were evaluated to be 3B or lower, which showed that small thin pieces of the coating were peeled off along with the edges of the cut as well as intersects of squares, and the affected area was less than 5 to 15% of the lattice.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A painted plated resin part comprising:
a resin part;
a trivalent chromium layer plated on the resin part; and
a painting containing a primer coat of a one-pack acryl resin paint formed on the trivalent chromium layer, and a topcoat of two-pack urethane resin paint formed on the primer coat.

2. The painted plated resin part according to claim 1, wherein a resin used in the resin part contains acrylonitrylbutadienestyrene or polycarbonate as a main component.

3. The painted plated resin part according to claim 1, wherein the one-pack acryl resin paint contains a resin having a carboxyl group as a main component.

4. The painted plated resin part according to claim 1, wherein the one-pack acryl resin paint contains polymethyl methacrylate as a main component.

5. An electronic device comprising:
an exterior member includes, in at least a part thereof, a painted plated resin part containing: a resin part; a trivalent chromium layer plated on the resin part; and a painting containing a primer coat of a one-pack acryl resin paint formed on the trivalent chromium layer, and a topcoat of two-pack urethane resin paint formed on the primer coat; and an electronic part housed in the exterior member.

6. The electronic device according to claim 5, wherein a resin used in the resin part contains acrylonitrylbutadienestyrene or polycarbonate as a main component.

7. The electronic device according to claim 5, wherein the one-pack acryl resin paint contains a resin having a carboxyl group as a main component.

8. The electronic device according to claim 5, wherein the one-pack acryl resin paint contains polymethyl methacrylate as a main component.

9. A method of painting a plated resin part, comprising:
forming a chromium plate layer by plating a surface of a resin part with trivalent chromium;
forming a primer coat by applying a one-pack acryl resin paint on the chromium plated layer;
forming a topcoat by applying a two-pack urethane resin paint formed on the primer coat, thereby finishing the painting.

10. The painting method according to claim 9, wherein a resin used in the resin part contains acrylonitrylbutadienestyrene or polycarbonate as a main component.

11. The painting method according to claim 10, wherein the one-pack acryl resin paint contains a resin having a carboxyl group as a main component.

12. The painting method according to claim 10, wherein the one-pack acryl resin paint contains polymethyl methacrylate as a main component.
